(19) United States
(12) Patent Application Publication
(10) Pub. No.: US 2012/0155084 A1
(43) Pub. Date: Jun. 21, 2012

(54) LIGHTING APPARATUS

(75) Inventors: HAN-TSUNG HSUEH, NEW TAIPEI CITY (TW); JIA-CHYI FENG, NEW TAIPEI CITY (TW)

(73) Assignees: KINPO ELECTRONICS, INC., New Taipei City (TW); CAL-COMP ELECTRONICS & COMMUNICATIONS COMPANY LIMITED, New Taipei City (TW)

(21) Appl. No.: 13/038,532

(22) Filed: Mar. 2, 2011

(30) Foreign Application Priority Data
Dec. 15, 2010 (TW) 99143946

(51) Int. Cl. F21V 21/00

(52) U.S. Cl. 362/249.01

(57) ABSTRACT

A lighting apparatus includes a base having a connection surface thereon; a transparent enclosure mounted on the connection surface, wherein the transparent enclosure and the connection surface define a receiving compartment; a support member disposed on the connection surface and within the receiving compartment, wherein the support member includes a bottom surface connected to the connection surface and a plurality of first mounting side-surfaces extending from the flanges of the bottom surface; and a lighting unit including at least three first lighting devices, and the first lighting devices respectively mounted on the first mounting side-surfaces, wherein each of the first lighting devices has a light axis, the connection surface has a normal axis, and a first included angle defined between the light axis of one of the first lighting devices and the normal axis of the connection surface is at least larger than 30 degrees.

### CROSS-REFERENCE TO RELATED APPLICATION

This application claims the priority benefit of Taiwan application serial no. 99143946, filed on Dec. 15, 2010. The entirety of above-mentioned patent application hereby incorporated by reference herein and made a part of this specification

### BACKGROUND OF THE INVENTION

1. Field of the Invention

The instant disclosure relates to a lighting apparatus; in particular, a lighting apparatus for emitting Omni-directional light.

2. Description of Related Art

LEDs have shown great promise to those interested in replacing conventional tungsten filament light sources to meet the requirement of high energy efficiency. Especially, LEDs are in commonly used as illumination devices.

LEDs are capable of emitting light when an electric field is applied Electroluminescence materials and have high efficiency. However, LEDs emit directional light. Such directional light is similar to a spot light for projecting a “point light” and the projection area has high light density. On the contrary, the area with the low light density forms a “dark zone”; therefore, the light of LEDs is different from the Omni-directional light of the traditional illumination devices such as fluorescent lamps, incandescent bulbs or saving energy bulbs. Traditionally, an optical device is disposed on the light axis of the LED for increasing the projection area of LED. In fact, the optical device simply decreases the dark zone and the problem still remains. As a result, LEDs are chosen and used in local illumination applications, such as commercial projection, spotlight or indicator light, but are not suitable for home illumination or office illumination.

For the improvement and the applications of LEDs, several standards are approved, such as UL/CUL, for LED products including LED lamp, LED bulbs and LED power supply. The standards are guidelines for manufacturing the relating products. The above-mentioned “Omni-directional light” is listed in the standards.

Thus, it is needed to increase the angle of the light of LED and the LEDs can meet the requirement of usage and the standards.

Therefore, in view of these difficulties, the inventor has developed ways to overcome these difficulties to yield dependable product with reliable results in production; the present invention addresses these difficulties and allows reliable production at high speed and overcomes the above problems.

### SUMMARY OF THE INVENTION

The object of the instant disclosure is to provide a lighting apparatus. By adjusting the arrangement and the angle of the lighting devices, the oriented light can be transferring to a homogenized and Omni-directional light.

Furthermore, another object of the instant disclosure is to provide a lighting apparatus which emits light complying with the commercial standards.

The lighting apparatus of the instant disclosure comprises a base having a connection surface thereon; a transparent enclosure mounted on the connection surface, wherein the transparent enclosure and the connection surface define a receiving compartment; a support member disposed on the connection surface and within the receiving compartment, wherein the support member includes a bottom surface connected to the connection surface and a plurality of first mounting side-surfaces extending from the flanges of the bottom surface; and a lighting unit including at least three first lighting devices, and the first lighting devices respectively mounted on the first mounting side-surfaces, wherein each of the first lighting devices has a light axis, the connection surface has a normal axis, and a first included angle defined between the light axis of one of the first lighting devices and the normal axis of the connection surface is at least larger than 30 degrees.

Another lighting apparatus of the instant disclosure comprises a base with a connection surface thereon; a transparent enclosure mounted on the connection surface, wherein the transparent enclosure and the connection surface define a receiving compartment; a support member disposed on the connection surface and within the receiving compartment, wherein the support member includes a bottom surface connected to the connection surface, four first mounting side-surfaces and four second mounting side-surfaces; and a lighting unit including a first lighting device mounted on each of the first mounting side-surfaces and a second lighting device mounted on each of the second mounting side-surfaces, wherein the first lighting device has a light axis, the connection surface has a normal axis, and a first included angle defined between the light axis of the first lighting device and the normal axis of the connection surface is at least larger than 30 degrees

The instant disclosure mainly offers a support member having mounting side-surfaces (i.e., the first and the second mounting side-surfaces) to mount the lighting devices thereon. By adjusting the position and the angle defined by the lighting device and the normal axis of the connection surface, the lighting apparatus can provide a homogenized and Omni-directional light.

In order to further appreciate the characteristics and technical contents of the instant disclosure, references are hereunder made to the detailed descriptions and appended drawings in connection with the instant disclosure. However, the appended drawings are merely shown for exemplary purposes, rather than being used to restrict the scope of the instant disclosure.

### BRIEF DESCRIPTION OF THE DRAWINGS

FIG. 1 shows a perspective diagram of the lighting apparatus of the first embodiment of the instant disclosure.

FIG. 1A shows a perspective diagram of the support member and the first lighting device of the first embodiment of the instant disclosure.

FIG. 1B shows a side-view diagram of the lighting apparatus of the first embodiment of the instant disclosure.

FIG. 2 shows a perspective diagram of the lighting apparatus of the second embodiment of the instant disclosure.

FIG. 3 shows a side-view diagram of the lighting apparatus of the third embodiment of the instant disclosure.

FIG. 4 shows a perspective diagram of the support member and the first lighting device of the fourth embodiment of the instant disclosure.

FIG. 5 shows a perspective diagram of the lighting apparatus of the fifth embodiment of the instant disclosure.

FIG. 5A shows a side-view diagram of the lighting apparatus of the fifth embodiment of the instant disclosure.

FIG. 5B shows a perspective diagram of the lighting apparatus of the sixth embodiment of the instant disclosure.

FIG. 5C shows a side-view diagram of the lighting apparatus of the seventh embodiment of the instant disclosure.

FIG. 6 shows an experimental optical property of the fifth embodiment of the instant disclosure.

FIG. 7 shows an experimental optical property of the seventh embodiment of the instant disclosure.

### DETAILED DESCRIPTION OF THE PREFERRED EMBODIMENTS

The instant disclosure provides a lighting apparatus. The lighting apparatus of instant disclosure set forth an Omni-direction lighting source by arranging the directional lighting devices in specific positions and angles. Moreover, the lighting apparatus of the instant disclosure shall comply with the requirement of the relevant luminaire standards.

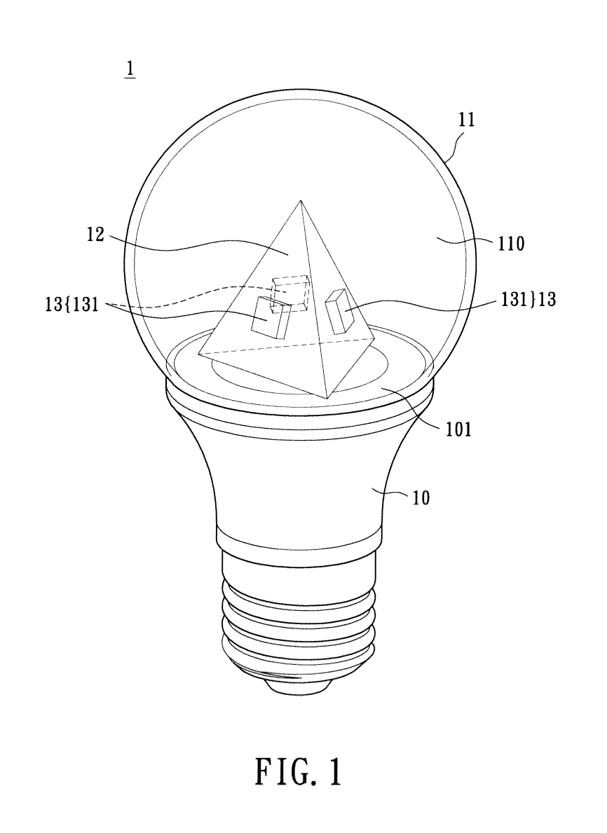

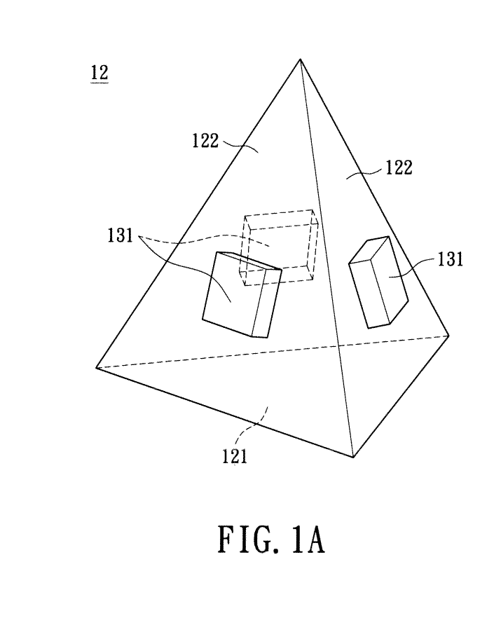

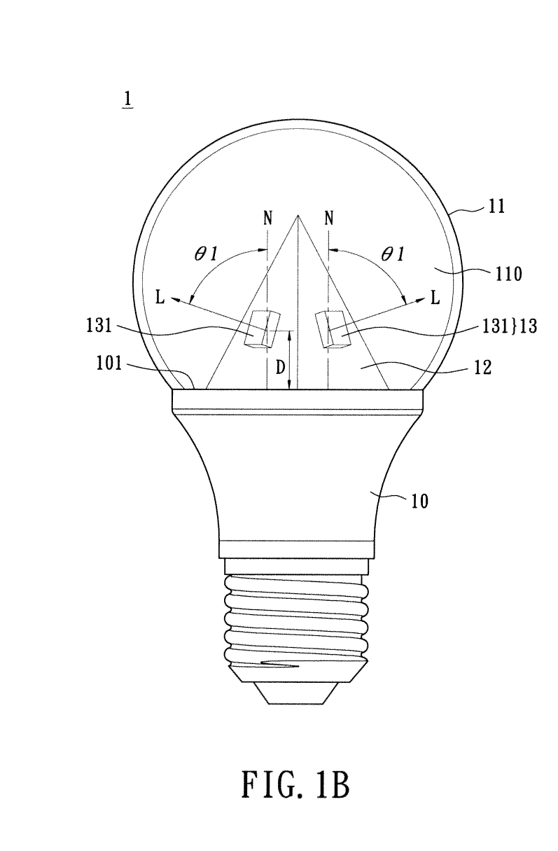

Please refer to FIGS. 1, 1A and 1B: where the lighting apparatus 1 of the first embodiment of the instant disclosure at least comprises a base 10, a transparent enclosure 11, a support member 12 and a lighting unit 13.

In the exemplary embodiment, the base 10 has a connection surface 101 thereon, and the transparent enclosure 11 and the support member 12 are mounted on the connection surface 101. In detail, the transparent enclosure 11 is a cover which is connected with the connection surface 101 so that the transparent enclosure 11 and the connection surface 101 can define a receiving compartment 110. The support member 12 is firmly connected to the connection surface 101 and is received within the receiving compartment 110. The support member 12 at least includes a bottom surface 121 connected to the connection surface 101 and a plurality of first mounting side-surfaces 122 extending from the flanges of the bottom surface 121. In this illustrated embodiment, the support member 12 is an awl-structure with a tri-angle bottom surface 121 and three first mounting side-surfaces 122 respectively extending from the three flanges of the bottom surface 121. The tri-angle bottom surface 121 can be mounted on the connection surface 101 by sintering, attaching, or mechanical fixing methods. The first mounting side-surfaces 122 are used to mounting the lighting unit 13. Furthermore, the support member 12 preferably provides a heat-dissipation function for the lighting unit 13, for example, the support member 12 may be made by metals.

The lighting unit 13 can have at least three first lighting devices 131 and the first lighting devices 131 are respectively mounted on the first mounting side-surfaces 122. As shown in FIG. 1, the lighting unit 13 of the illustrated embodiment has three first lighting devices 131, and each of the first lighting devices 131 is mounted on one first mounting side-surface 122.

On the other hand, each of the first lighting devices 131 has a light axis “L” and the connection surface 101 has a normal axis “N” (i.e., the perpendicular line). A first included angle θ1 defined between the light axis “L” of one of the first lighting devices 131 and the normal axis “N” of the connection surface 101 is at least larger than 30 degrees, as shown in FIG. 1B. Please note that the first included angles θ1 can be the same or different from each other in case that the first included angles θ1 satisfy the above-mentioned limitation.

The lighting apparatus of the instant disclosure provides Omni-direction lighting source by the arrangement of first lighting devices 131 respectively mounted on the first mounting side-surfaces 122 and the angle limitation of the first included angle θ1. More specifically, the lighting properties of the instant lighting apparatus meet the requirement of the commercial standards. For example, at least 5% of the total lumen is distributed between 135 degree and 180 degree, or the luminous intensity (candelas) distributed on vertical planes at 0 degree, 45 degree and 90 degree are vertically symmetrical. The lighting apparatus of the instant disclosure may be determined to compare the commercial standards as following.

Please refer to FIG. 1B, which shows each of the first lighting devices 131 and the connection surface 101 has a minimum distance “D” therebetween. The minimum distance “D” is larger than 5 mm, preferably is lager than 8 mm. In other words, the distance determined between each of the first lighting devices 131 and the connection surface 101 along the normal axis “N” of the connection surface 101 is larger than 5 mm, preferably is lager than 8 mm.

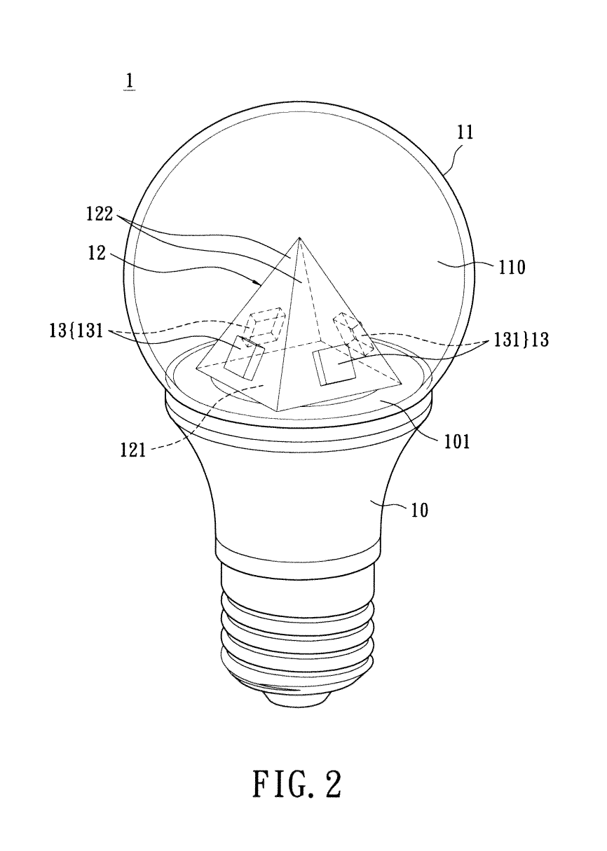

Please refer to FIG. 2, which shows the second embodiment of the instant disclosure. In this exemplary embodiment, the support member 12 has four first mounting side-surfaces 122 and the lighting unit 13 has four first lighting devices 131. The four first lighting devices 131 are respectively mounted on the four first mounting side-surfaces 122. In other words, each first mounting side-surface 122 has one first lighting device 131 thereon. Similarly, the lighting apparatus of the second embodiment provides an Omni-direction lighting source by the arrangement of first lighting devices 131 respectively mounted on the first mounting side-surfaces 122 and the angle limitation of the first included angle θ1 so as to meet the requirement of the standards.

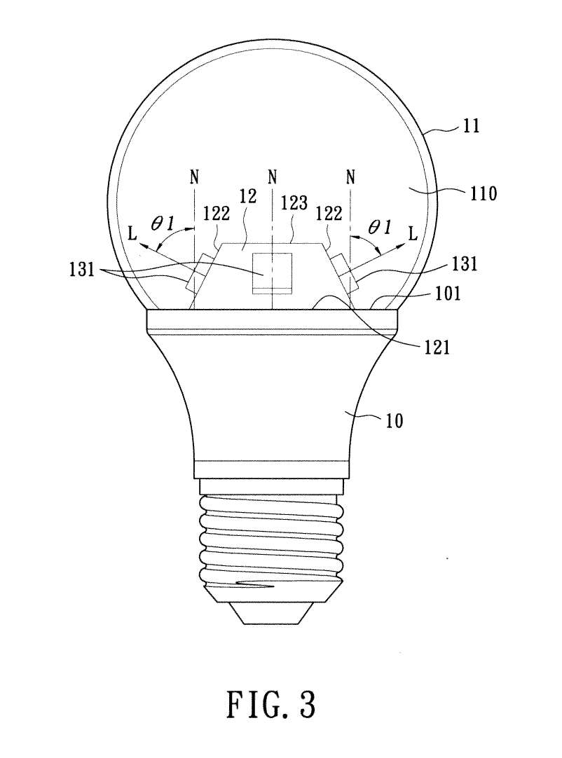

Please refer to FIG. 3, which shows the third embodiment of the instant disclosure. The support member 12 further has a top surface 123 opposite to the bottom surface 121. In other words, the support member 12 has the top surface 123 and the bottom surface 121 respectively on the top and the bottom thereof, and the four first mounting side-surfaces 122 are formed between the top surface 123 and the bottom surface 121. The lighting unit 13 has four first lighting devices 131 which are respectively mounted on the four first mounting side-surfaces 122. In other words, the top surface 123 has no first lighting device 131 mounted thereon for improving the Omni-direction lighting distribution. As a result, the lighting apparatus of the third embodiment provides an Omni-direction lighting source by the arrangement of first lighting devices 131 respectively mounted on the first mounting side-surfaces 122 (not on the top surface 123) and the angle limitation of the first included angle θ1 so as to meet the requirement of the standards.

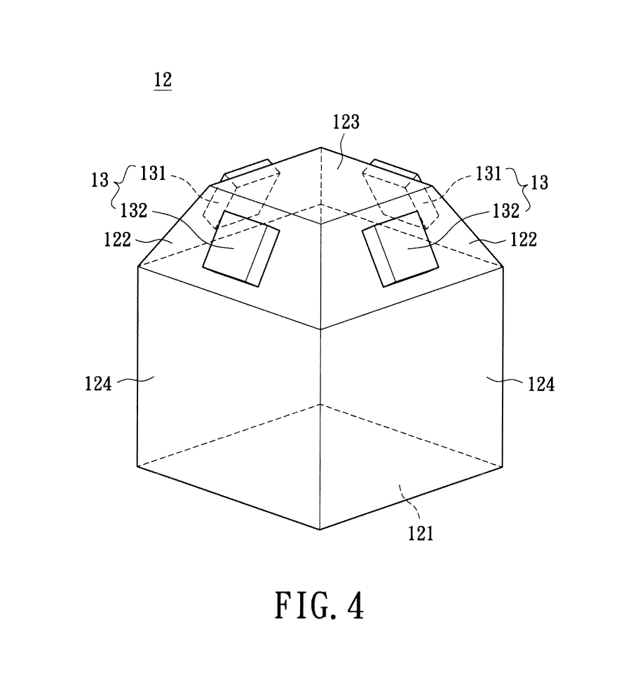

Please refer to FIG. 4, which shows the fourth embodiment of the instant disclosure. The support member 12 further has a plurality of second mounting surfaces 124 formed between the bottom surface 121 and the first mounting surfaces 122. The support member 12 of the exemplary embodiment has a cylindrical-like structure. The lighting unit 13 has four first lighting devices 131 which are respectively mounted on the four first mounting side-surfaces 122. In other words, the top surface 123 and the second mounting surfaces 124 have no first lighting device 131 mounted thereon for improving the Omni-direction lighting distribution. Similarly, the lighting apparatus of the fourth embodiment provides an Omni-direction lighting source by the arrangement of first lighting devices 131 respectively mounted on the first mounting side-surfaces 122 (not on the top surface 123 and the second mounting surfaces 124) and the angle limitation of the first included angle θ1 so as to meet the requirement of the standards.

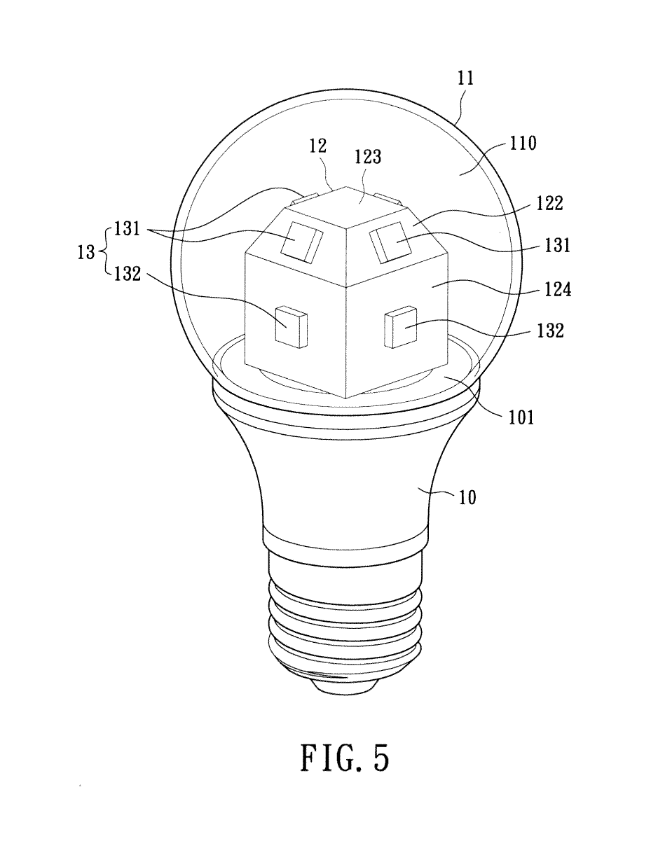

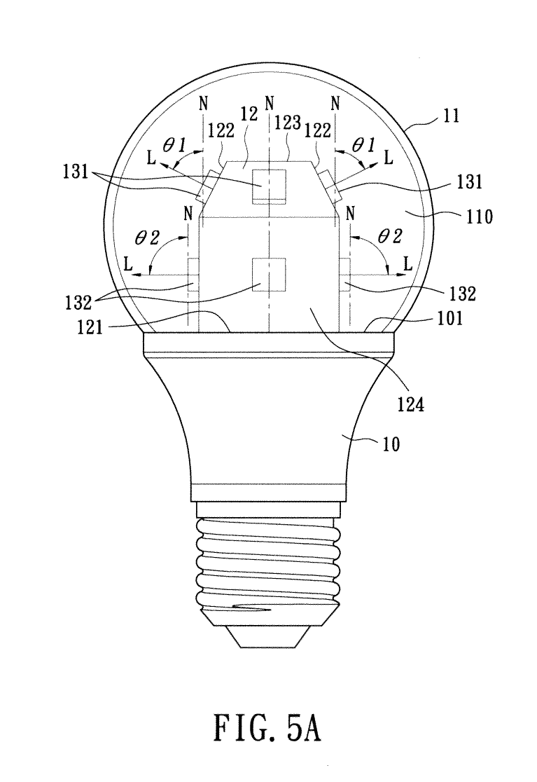

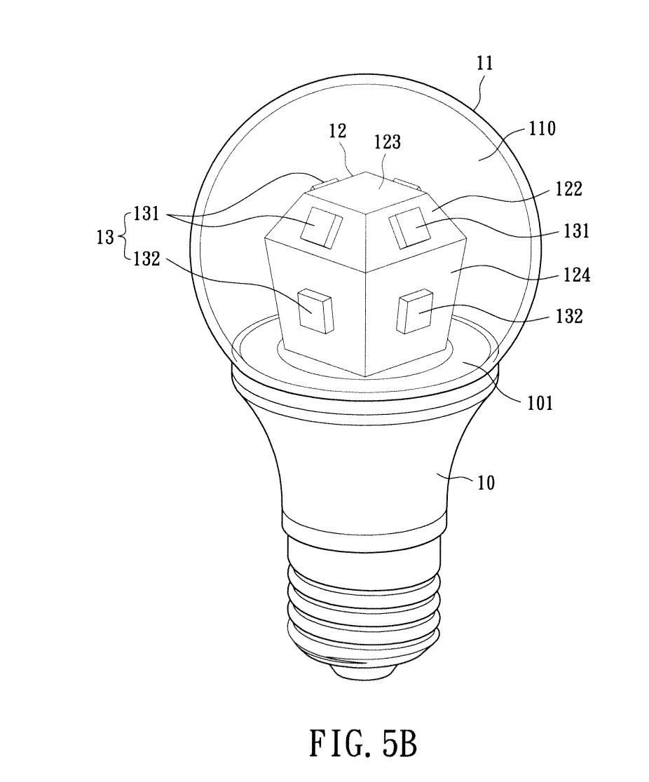

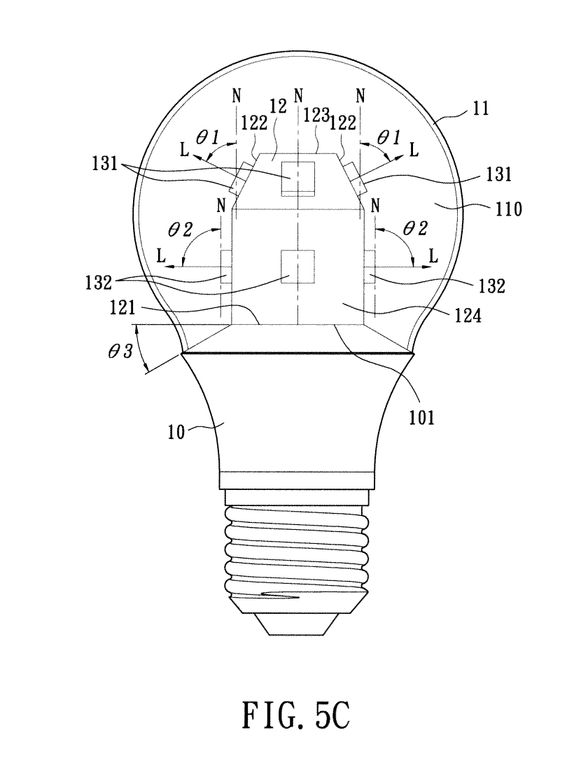

Please refer to FIGS. 5 and 5A, which show the fifth embodiment of the instant disclosure. The lighting unit 13 further has a plurality of second lighting devices 132 and the second lighting devices 132 are respectively mounted on the second mounting surfaces 124 correspondingly to the first lighting devices 131. On the other hand, each of the second lighting devices 132 has a light axis “L” and a second included angle θ2 is defined between the light axis “L” of one of the second lighting devices 132 and the normal axis “N” of the connection surface 101. Preferably, the second included angle θ2 is larger than the first included angle θ1. As shown in FIG. 5A, the second included angle θ2 is about 90 degrees and the first included angle θ1 can be ranged from about 30 degrees to 90 degrees (Please note that the first included angle θ1 can not be equal to 90 degrees in structure). In other words, the second included angle θ2 is larger than the first included angle θ1. FIG. 5B shows the sixth embodiment and the second included angle θ2 is larger than 90 degrees. Therefore, the cross-section area of the support member 12 is increased from the bottom surface 121 to the top end of the second mounting surfaces 124 and then is decreased form the top end of the second mounting surfaces 124 to the top surface 123. Similarly, the second included angle θ2 is larger than the first included angle θ1 in the sixth embodiment. Please refer to FIG. 5C; the seventh embodiment is shown. The base 10 further has a chamfering portion around the side end of the connection surface 101. The surface of the chamfering portion and the connection surface 101 has a third included angle θ3 defined therebetween. The chamfering portion may be used to reflect the light so that the more Omni-directional light is provided for improving the light uniformity of the lighting apparatus.

In addition, the position of each second lighting device 132 is preferably aligned to the position of the corresponding first lighting device 131. As shown in FIGS. 5A or 5C, each first lighting device 131 and the corresponding second lighting device 132 are arranged along the normal axis “N” of the connection surface 101 so that said one first lighting device 131 is disposed above the corresponding second lighting device 132 along the normal axis “N” of the connection surface 101. The arrangement of the first lighting device 131 and the corresponding second lighting device 132 can be applied to form the Omni-directional lighting distribution.

In the embodiment shown as FIGS. 5 and 5A, the support member 12 includes a bottom surface 121 connected to the connection surface 101, four first mounting side-surfaces 122, four second mounting side-surfaces 124 and a top surface 123. The lighting unit 13 includes a first lighting device 131 mounted on each of the first mounting side-surfaces 122 and a second lighting device 132 mounted on each of the second mounting side-surfaces 124. In other words, the lighting unit 13 has four first lighting devices 131 and four second lighting devices 132. Furthermore, the top surface 123 has no lighting device (i.e., the first and the second lighting devices) mounted thereon for avoiding the condensed lighting distribution.

As discussed above, each second lighting device 132 is substantially aligned and positioned under the corresponding the first lighting device 131. In addition, the second included angle θ2 is larger than the first included angle θ1 and the minimum distance D between the second lighting device 132 and the connection surface 101 is larger than 5 mm, preferably larger than 8 mm. Please note that the position of the first lighting device 131 is higher than the position of the second lighting device 132; therefore, the minimum distance D between the first lighting device 131 and the connection surface 101 shall be naturally met the above limitation.

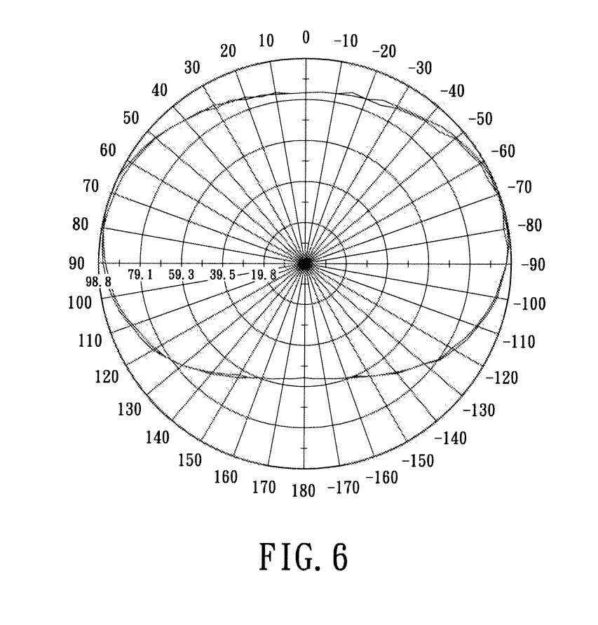

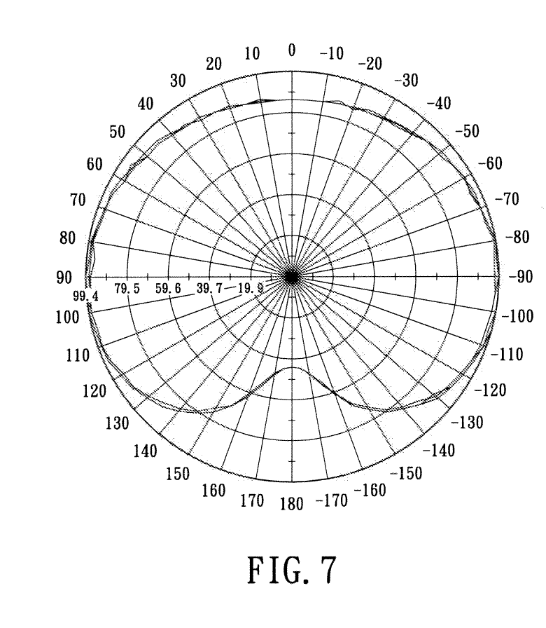

Please refer to FIG. 6, which show the lighting property of the lighting apparatus of the fifth embodiment. In the fifth embodiment, the first included angle θ1 is 60 degrees and the second included angle θ2 is 90 degrees. The transparent enclosure 11 is made of a quasi-Lambertian scattering material. As shown in FIG. 6, about 10% of the total lumen of the instant lighting apparatus is distributed between 135 degree and 180 degree, which meets the requirement that at least 5% of the total lumen is distributed between 135 degree and 180 degree. Please refer to FIG. 7, which show the lighting property of the lighting apparatus of the seventh embodiment. In the seventh embodiment, the first included angle θ1 is 60 degrees, the second included angle θ2 is 130 degrees and the third included angle θ3 is 60 degrees. The transparent enclosure 11 is made of a quasi-Gaussian scattering material. As shown in FIG. 7, about 10% of the total lumen of the instant lighting apparatus is distributed between 135 degree and 180 degree, which meets the requirement that at least 5% of the total lumen is distributed between 135 degree and 180 degree. Moreover, the following lighting property of the lighting apparatus of the seventh embodiment can meet the requirement of commercial standards: the luminous intensity (candelas) distributed on vertical planes at 0 degree, 45 degree and 90 degree, which are measured in FIGS. 6 and 7 are vertically symmetrical. The lighting intensity is smooth distributed at 0 degree to 135 degree. The difference ratio (AM) is less than 20%, wherein A represents a difference between the average of lighting density at 0 degree to 135 degree and a lighting density at any degree from 0 degree to 135 degree and B represents the average of lighting density at 0 degree to 135 degree.

Please note that the first lighting device 131 and the second lighting device 132 can be any lighting source, for example, light emitting diode (LED). LED module, LED array and so on.

Based on the above discussions, the instant disclosure has the following advantages. First, the issue of the traditional oriented light is solved. In other words, the traditional oriented lighting source (i.e., the first and the second lighting devices) can be mounted on the support member so that the instant lighting apparatus provides a homogenized light with wide angle. Secondly, the lighting properties of the instant lighting apparatus can meet the requirement of the commercial standards and instant lighting apparatus can be widely applied in many applications.

The descriptions illustrated supra set forth simply the preferred embodiments of the instant disclosure; however, the characteristics of the instant disclosure are by no means restricted thereto. All changes, alternations, or modifications conveniently considered by those skilled in the art are deemed to be encompassed within the scope of the instant disclosure delineated by the following claims.

What is claimed is:

1. A lighting apparatus, comprising:
a base having a connection surface thereon;
a transparent enclosure mounted on the connection surface, wherein the transparent enclosure and the connection surface define a receiving compartment;
a support member disposed on the connection surface and within the receiving compartment, wherein the support member includes a bottom surface connected to the connection surface and a plurality of first mounting side-surfaces extending from the flanges of the bottom surface; and
a lighting unit including at least three first lighting devices, and the first lighting devices respectively mounted on the first mounting side-surfaces, wherein each of the first lighting devices has a light axis, the connection surface has a normal axis, and a first included angle defined between the light axis of one of the first lighting devices and the normal axis of the connection surface is at least larger than 30 degrees.

2. The lighting apparatus of claim 1, wherein the support member further has a top surface opposite to the bottom surface, and none of the first lighting devices is mounted on the top surface.

3. The lighting apparatus of claim 2, wherein the support member further has a plurality of second mounting surfaces formed between the bottom surface and the first mounting surfaces, and none of the first lighting devices is mounted on the second mounting surfaces.

4. The lighting apparatus of claim 2, wherein the support member further has a plurality of second mounting surfaces formed between the bottom surface and the first mounting surfaces, the lighting unit further has a plurality of second lighting devices, the second lighting devices are respectively mounted on the second mounting surfaces correspondingly to the first lighting devices.

5. The lighting apparatus of claim 4, wherein each of the second lighting devices has a light axis, and a second included angle defined between the light axis of one of the second lighting devices and the normal axis of the connection surface is larger than the first included angle.

6. The lighting apparatus of claim 5, wherein one of the first lighting devices and the corresponding second lighting device are arranged along the normal axis of the connection surface so that one of the first lighting devices is disposed above the corresponding second lighting device along the normal axis of the connection surface.

7. The lighting apparatus of claim 1, wherein each of the first lighting devices and the connection surface has a minimum distance therebetween, and the minimum distance is lager than 5 mm.

8. The lighting apparatus of claim 1, wherein the base further has a chamfering portion, the surface of the chamfering portion and the connection surface has a third included angle defined therebetween.

9. A lighting apparatus, comprising:
a base with a connection surface thereon;
a transparent enclosure mounted on the connection surface. wherein the transparent enclosure and the connection surface define a receiving compartment;
a support member disposed on the connection surface and within the receiving compartment, wherein the support member includes a bottom surface connected to the connection surface, four first mounting side-surfaces and four second mounting side-surfaces; and
a lighting unit including a first lighting device mounted on each of the first mounting side-surfaces and a second lighting device mounted on each of the second mounting side-surfaces, wherein the first lighting device has a light axis, the connection surface has a normal axis, and a first included angle defined between the light axis of the first lighting device and the normal axis of the connection surface is at least larger than 30 degrees.

10. The lighting apparatus of claim 9, wherein the second lighting device has a light axis, and a second included angle defined between the light axis of the second lighting device and the normal axis of the connection surface is larger than the first included angle.

11. The lighting apparatus of claim 10, wherein the first lighting device and the corresponding second lighting device are arranged along the normal axis of the connection surface so that the first lighting device is disposed above the corresponding second lighting device along the normal axis of the connection surface.

12. The lighting apparatus of claim 9, wherein the base further has a chamfering portion, the surface of the chamfering portion and the connection surface has a third included angle defined therebetween.
